(19) United States
(12) Patent Application Publication
(10) Pub. No.: US 2005/0180439 A1
(43) Pub. Date: Aug. 18, 2005

(54) Network system, terminal setting method, address resolving server, and client terminal

(76) Inventors: Wataru Kondo, Tokyo (JP); Kenichi Kitamura, Kanagawa (JP); Raku Shirasawa, Saitama (JP)

Correspondence Address: William S. Frommer, Esq.;FROMMER LAWRENCE & HAUG LLP, 745 Fifth Avenue, New York, NY, 10151, US

(21) Appl. No.: 11/039,481

(22) Filed: Jan. 20, 2005

(30) Foreign Application Priority Data
Jan. 21, 2004 (JP) 2004-012756

(51) Int. Cl. H04L 12/28

(52) U.S. Cl. 370/401; 370/395.54

(57) ABSTRACT

An RARP server receives ARP requests that application servers send when they get started. The RARP server records MAC addresses and IP addresses of the application servers. Thereafter, when a client terminal tries to execute an application and needs to access an application server, if the client terminal does not know an IP address of the application server, the client terminal broadcasts an RARP request that describes an MAC address of the application server and obtains an IP address of the application server from the RARP server. Thus, the client terminal accesses the server with the MAC address and IP address of the application server and performs a predetermined data communication.

### BACKGROUND OF THE INVENTION

1. Field of the Invention

The present invention relates to a network system, a terminal setting method, an address resolving server, and a client terminal that can easily resolve a problem of IP addresses.

2. Description of the Related Art

At present, network systems to which a plurality of terminals are connected have been widespread to homes. The network systems allow the users to use applications through the Internet at each room and to watch moving pictures and listen to sound. In these network systems, packets are sent and received between terminals in accordance with the Internet Protocol (IP). In other words, packets are sent and received with IP addresses. Thus, each terminal of the network systems needs to know an IP address of a remote party's terminal in advance.

In addition, each terminal needs to transmit an Ethernet (registered trademark) frame to a Media Access Control (MAC) address of a receiving party's terminal. Thus, before each terminal (sending party's terminal) sends an Ethernet frame to a receiving party's terminal, the sending terminal needs to know not only an IP address of the receiving party's terminal, but an MAC address thereof. When the sending party's terminal knows only the IP address, not the MAC address, the MAC address is obtained in accordance with a protocol named Address Resolution Protocol (ARP). An MAC address is a physical address corresponding to a network interface card (NIC) or the like of each terminal. An MAC address is composed of a manufacturer number and a unique number assigned thereby.

In addition, a terminal such as a disc-less workstation does not have its IP address. Thus, when the terminal gets started, it obtains an IP address from its MAC address. This IP address is obtained in accordance with a protocol named reverse ARP (RARP). ARP is prescribed in Request for Comment (RFC) 826. RARP is prescribed in RFC 903.

Next, with reference to FIG. 1 to FIG. 4, outlines of ARP and RARP will be described. FIG. 1 is a schematic diagram showing the network structure of a network system. The network system is composed of one network and four terminals (terminal 100, terminal 110, terminal 120, and terminal 130) connected thereto. Each terminal has an ARP table (ARP cache). The network may be not only a wireless system, but a wired system.

FIG. 1 also shows MAC addresses and IP addresses of these terminals. The MAP address and IP address of the terminal 100 are MAC-100 and IP-100, respectively. In the Ethernet system, a real MAC address is binary data of six bytes. An IP address of IPv4 is binary data of four bytes. However, this specification adopts a convenient notation such as MAC-100 and so forth.

The MAC address and IP address of the terminal 110 are MAC-110 and IP-110, respectively. The MAC address and IP address of the terminal 120 are MAC-120 and IP-120, respectively. Likewise, the MAC address and IP address of the terminal 130 are MAC-130 and IP-130, respectively.

In the network system shown in FIG. 1, it is assumed that a packet is sent from the terminal 100 to the terminal 130. In addition, it is assumed that although the terminal 100 knows the IP address of the terminal 130, the terminal 100 does not know the MAC address of the terminal 130. When the terminal 100 sends a packet to the terminal 130, as described above, the terminal 100 needs to designate the MAC address of the terminal 130. Thus, at first, the terminal 100 sends ARP request packets to all terminals over the network so as to obtain the MAC address of the terminal 130. This operation is referred to as so-called broadcast. When the network is a wired local area network (LAN), the ARP request packets are broadcast to terminals of one segment as a transmission range. When the network is a wireless LAN, the ARP request packets are broadcast to terminals in a predetermined area as a transmission range.

FIG. 2A shows an Ethernet frame 200 that the terminal 100 sends for the ARP request. The Ethernet frame 200 contains a receiving party's MAC address, a sending party's MAC address, and an IP packet. In this case, the IP packet corresponds to the foregoing ARP request packet. It should be noted that the items of the Ethernet frame 200 shown in FIG. 2A are only those that are necessary for explanation of the related art. Thus, the items of the Ethernet frame 200 do not restrictively represent the layout thereof. The Ethernet frame 200 has MAC addresses referenced in the network layer (of an open systems interconnection (OSI) reference model) and MAC addresses referenced in a layer lower than the network layer. The former is referred to as MAC addresses 2 (receiving party's MAC address 2 and sending party's MAC address 2), whereas the latter is referred to as MAC addresses 1 (receiving party's MAC address 1 and sending party's MAC address 1).

The receiving party's MAC address 1 of the Ethernet frame 200 describes a value (F-F) of which all bits are 1's. Thus, the frame is broadcast over the network. The sending party's MAC address 1 describes MAC-100 as the MAC address of the terminal 100. A protocol type of the IP packet describes information that represents the ARP request. In this example, the protocol type is simply denoted. In reality, the ARP request is represented by a protocol bit and an operation bit. Like the sending party's MAC address 1, the sending party's MAC address 2 describes MAC-100 as the MAC address of the terminal 100. A receiving party's IP address and a sending party's IP address of the IP packet describes IP-130 and IP-100, respectively.

The broadcast Ethernet frame 200 is received by the terminal 110, terminal 120, and terminal 130. Arrowed dotted lines 140 shown in FIG. 1 represent that the Ethernet frame 200 is broadcast. When these terminals receive the Ethernet frame 200, they determine whether or not the receiving party's IP address of the Ethernet frame 200 matches the local IP address. When the receiving party's IP address matches the local IP address of a terminal, it sends an ARP response packet to the sending party's IP address. The ARP response packet is represented by an arrowed dotted line denoted by reference numeral 150 shown in FIG. 1. In this case, the receiving party's IP address of the Ethernet frame 200 is the terminal 130. Thus, only the terminal 130 sends the ARP response packet to the terminal 100. At that point, the terminal 130 obtains the MAC address of the terminal 100 with data of at least the sending party's MAC address 1.

In addition, the terminal 130 registers the MAC address and the IP address as a pair 205 as shown in FIG. 2B to an ARP table 190. Thus, when the terminal 130 sends a packet to the terminal 100, the terminal 130 can reference the ARP table 190 and obtain the MAC address of the terminal 100. As a result, unlike the terminal 100, the terminal 130 does not need to send the ARP request packet to the terminal 100. In addition, it is preferred that the contents of the ARP table 190 should be cleared at predetermined intervals because the IP addresses of the terminals are updated and unnecessary entries need to be deleted.

When the receiving party's IP address of the Ethernet frame 200 does not match the local IP address, namely the terminal 110 and the terminal 120 discard the Ethernet frame 200.

The terminal 130 sends an Ethernet frame 210 that contains an ARP response packet as shown in FIG. 2C to the terminal 100. A receiving party's MAC address 1 and a receiving party's MAC address 2 of the Ethernet frame 210 describe MAC-100. A sending party's MAC address 1 and a sending party's MAC address 2 of the Ethernet frame 210 describe MAC-130 as the MAC address of the terminal 130. A protocol type of an IP packet of the Ethernet frame 210 describes information that represents an ARP response. Like FIG. 2A, the protocol type is simply denoted. A receiving party's IP address and a sending party's IP address of the Ethernet frame 210 describe IP-100 and IP-130, respectively. When the terminal 100 receives the Ethernet frame 210, the terminal 100 knows that the MAC address of the terminal 130 is MAC-130.

The terminal 100 registers the MAC address and the IP address as a pair 215 as shown in FIG. 2D to the ARP table 160. Thus, when the terminal 100 sends a packet to the terminal 130 again, the terminal 100 can reference the ARP table 160 and obtain the MAC address of the terminal 130. Thus, whenever the terminal 100 sends a packet to the terminal 130, the terminal 100 does not need to send the foregoing ARP request packet to the terminal 130.

Next, with reference to FIG. 1, RARP will be described. In this case, it is assumed that the terminal 130 is an RARP server. In addition, it is assumed that the RARP server has an ARP table 220. The ARP table 220 contains IP addresses corresponding to the MAC addresses of the terminal 100, terminal 110, and terminal 120.

An RARP request packet is a packet that a disc-less workstation or the like sends to another terminal and obtains an IP address of the disc-less workstation. Since a disc-less workstation does not have a recording means such as a hard disk, the disc-less workstation cannot store its IP address. When the disc-less workstation communicates with a terminal in accordance with the IP, the disc-less workstation needs to obtain its IP address from a recording means of another terminal. Although the disc-less workstation needs its identifier, an MAC address obtained from a NIC or the like is used. Now, it is assumed that the terminal 100 shown in FIG. 1 is a disc-less workstation. In this case, when for example the terminal 100 gets started, it broadcasts an RARP request packet (Ethernet frame) to the network. As denoted by arrowed dotted lines 140 shown in FIG. 1, the terminal 100 sends the frame to each terminal over the network. The terminal 100 broadcasts the frame to the network because the terminal 100 cannot identify a terminal that is the RARP server.

FIG. 4A shows an Ethernet frame 230 that contains an RARP request packet. A receiving party's MAC address 1 of the Ethernet frame 230 describes a value (F-F) of which all bits are 1's so as to broadcast the frame. A sending party's MAC address 1 of the Ethernet frame 230 describes MAC-100 as the MAC address of the terminal 100. A protocol type of an IP packet of the Ethernet frame 230 describes information that represents an RARP request. Like the foregoing, the protocol type is simply denoted. Like the sending party's MAC address 1, a sending party's MAC address 2 of the Ethernet frame 230 describes AC-100 as the MAC address of the terminal 100. A receiving party's MAC address and a sending party's IP address of the Ethernet frame 230 describe no values.

When the terminal 130, which is an RARP server, receives the Ethernet frame 230, the terminal 130 references the protocol type thereof and determines that the Ethernet frame 230 should be a frame that the terminal 130 has to process. As a result, the terminal 130 generates an RARP response packet and sends back it to the terminal 100. Since the process of the RARP server does not operate in the other terminals, when they receive the RARP request packet, they discard it.

FIG. 4B shows an Ethernet frame 240 that contains an RARP response packet that the terminal 130 sends to the terminal 100. A receiving party's MAC address 1 and a receiving party's MAC address 2 of the Ethernet frame 240 describe MAC-100. A sending party's MAC address 1 and a sending party's MAC address 2 of the Ethernet frame 240 describe MAC-130. A protocol type of an IP packet of the Ethernet frame 240 describes information that represents an RARP response. Like the foregoing, the protocol type is simply denoted. The terminal 130 references the contents of for example the sending party's MAC address 2 of the RARP request packet, searches the ARP table 220 for the corresponding IP address, and sets the obtained IP address to the receiving party's IP address of the RARP response packet. Thus, a receiving party's IP address of the Ethernet frame 240 describes IP-100. A ending party's IP address of the Ethernet frame 240 describes IP-130.

When the terminal 100 receives the RARP response packet and references the receiving party's IP address, the terminal 100 can know its IP address. The RARP response packet is sent as denoted by an arrowed dotted line 150 shown in FIG. 1.

Although the number of terminals in which RARP is installed is small because of its necessity, ARP needs to be installed to most of terminals. As described above, when an IP address of a receiving party's terminal to which a packet is sent is known, an MAC address of the terminal is obtained in accordance with ARP. Thus, in a conventional server-client type home-use network system, to use terminals in the network system, predetermined operations are required for them. For a client terminal, the following operations are required.
(1) set an IP address to the client terminal, and
(2) register IP addresses of other terminals (including a server) to the client terminal.

After these operations, the client terminal designates an IP address of the other terminal and sends a packet to the terminal. For example, when a client terminal sends a request to the server, the terminal describes the IP address of the server to the header portion of the IP packet and transmits it to the server.

However, whenever a client terminal is added, if these operations are required, the user may hesitate in these settings or make mistakes therefor. To solve such a problem, Universal Plug and Play (UPnP) would be used. UPnP is a protocol for exchanging information (in the foregoing example, IP addresses) of devices connected over the IP network so that they can automatically recognize the other ones.

The following patent document discloses an information processing apparatus for converting a command so that a UPnP device in which UPnP is installed controls an AV/C device connected to the IEEE (Institute of Electrical and Electronics Engineers) 1394 high speed serial bus where the UPnP device and the AV/C device are connected over a network system. [Patent Document 1] Japanese Patent Laid-Open Publication No. 2003-46535.

With this information processing apparatus, a UPnP device can send commands to AV/C devices such as an audio device and a video device so as to build a network system such as a home theater.

However, in the foregoing network system, the UPnP devices and the system structure should be largely changed. In addition, terminals of old models do not have UPnP. Thus, assuming that terminals connected to the network system are UPnP devices, terminals of old models cannot be used.

Although all terminals that are sold as a system connected to one network system may be UPnP devices, this method would not be desirable from a point of view of cost (for development of portion with respect to UPnP, connection tests, and increase of memory capacity corresponding to increase of modules).

### OBJECTS AND SUMMARY OF THE INVENTION

Therefore, an object of the present invention is to provide a network system, a terminal setting method, an address resolving server, and a client terminal that allow terminals connected to the network system to be easily set without need to largely change the terminals and the system.

Another object of the present invention is to provide a network system, a terminal setting method, an address resolving server, and a client terminal that allow IP addresses of terminals such as servers that terminals connected to the network system use to be set. The user can set an IP address of each terminal. In other words, the IP address of each terminal can be set by the user, not universal. Thus, if the user can easily set the terminal, it is very effective.

Assuming that several mobile (portable) devices that have a wireless LAN connection function are used in a home LAN environment, if so-called link local addresses (for example, 192.254.0.0/16) are pre-assigned to the mobile devices, whenever they are used, their IP addresses are automatically assigned to them.

A first aspect of the present invention is a network system having a client terminal, an application server, and an address network server that are connected to an IP network, wherein the client terminal has first recording means for recording an MAC address of an application server to which an application of the client terminal is connected, the application providing a predetermined service to the user, wherein the address resolving server has second recording means for recording an MAC address and an IP address of the application server, and wherein when the client terminal broadcasts a predetermined request that contains the MAC address of the application server to the network, the address resolving server is configured to receive the predetermined request, obtain the IP address corresponding to the MAC address of the application server from the second recording means, and send back a predetermined response that contains the obtained IP address to the client terminal.

A second aspect of the present invention is a terminal setting method for a network system having a client terminal, an application server, and an address network server that are connected to an IP network, the client having first recording means for recording an MAC address of an application server to which an application of the client terminal is connected, the application providing a predetermined service to the user, the address resolving server having second recording means for recording an MAC address and an IP address of the application server, the terminal setting method comprising the steps of: causing the client terminal to broadcast a predetermined request that contains the MAC address of the application server to the network; causing the address resolving server to receive the predetermined request, obtain the IP address corresponding to the MAC address of the application server from the second recording means, and send back a predetermined response that contains the obtained IP address to the client terminal.

A third aspect of the present invention is an address resolving server connected to a client terminal and an application server through an IP network, the address resolving server comprising: second recording means for recording an MAC address and an IP address of the application server, wherein when the client terminal broadcasts a predetermined request that contains the MAC address of the application server to the network, the address resolving server is configured to receive the predetermined request, obtain the IP address corresponding to the MAC address of the application server from the second recording means, and send back a predetermined response that contains the obtained IP address to the client terminal.

A fourth aspect of the present invention is a client terminal, connected to an application server and an address resolving server through an IP network, for executing an application connected to the application server so as to provide a predetermined service to the user, the client terminal comprising: first recording means for recording an MAC address of the application server, wherein the client terminal is configured to broadcast a predetermined request that contains the MAC address of the application server to the network so as to obtain an IP address corresponding to the MAC address of the application server to be connected.

According to the present invention, an IP address of an application server that a client terminal uses can be easily set without need to largely change software of the client terminal and an address resolving server.

These and other objects, features and advantages of the present invention will become more apparent in light of the following detailed description of a best mode embodiment thereof, as illustrated in the accompanying drawings.

### BRIEF DESCRIPTION OF THE DRAWINGS

The invention will become more fully understood from the following detailed description, taken in conjunction with the accompanying drawing, wherein similar reference numerals denote similar elements, in which:

FIG. 1 is a schematic diagram showing a network structure of a conventional network system;

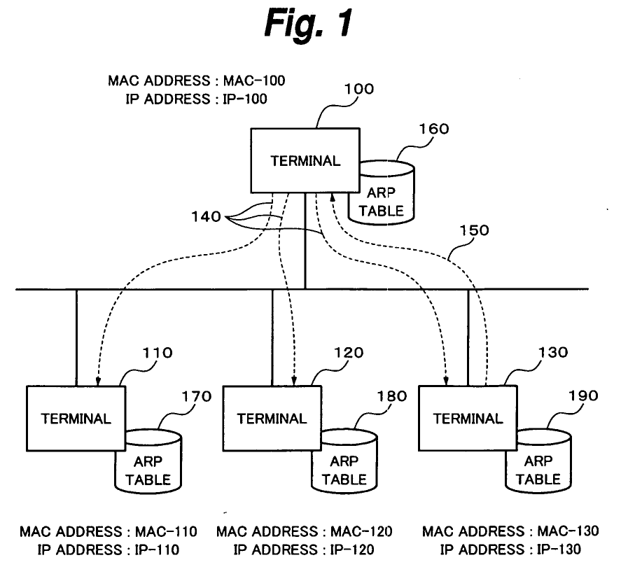

FIGS. 2A, 2B, 2C, and 2D are schematic diagrams showing contents of a frame containing an ARP request and contents of a frame containing an ARP response;

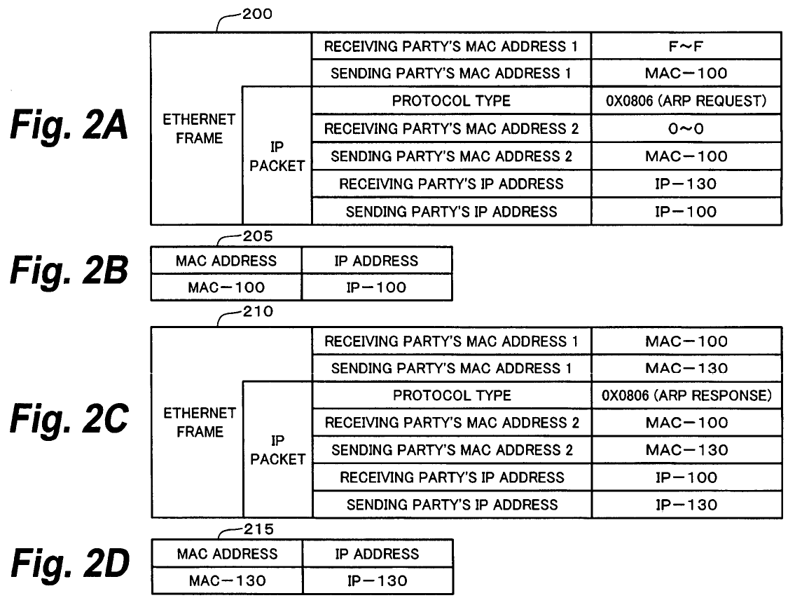

FIG. 3 is a schematic diagram showing contents of an ARP table;

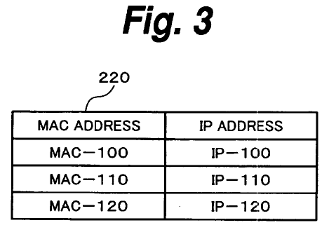

FIGS. 4A and 4B are schematic diagrams showing contents of a frame containing an RARP request and contents of a frame containing an RARP response, respectively;

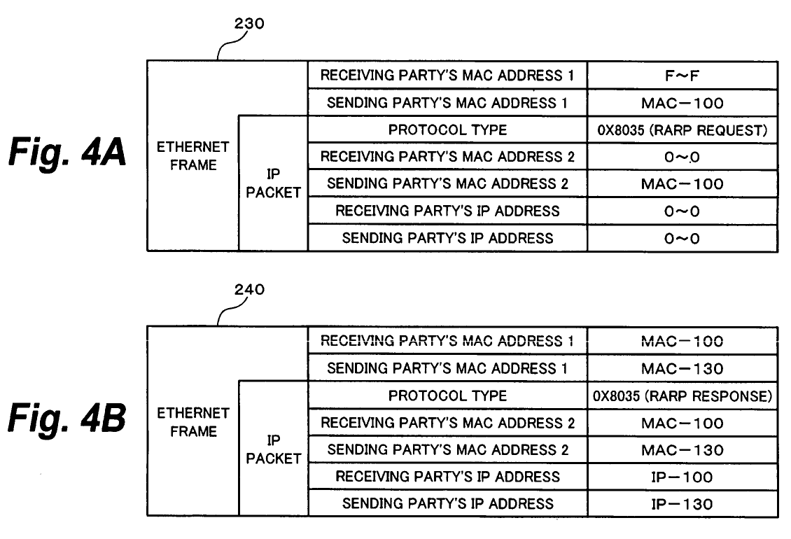

FIG. 5 is a schematic diagram showing a network structure of a network system according to an embodiment of the present invention;

FIGS. 6A and 6B are schematic diagrams showing an example of a frame containing an RARP request that a client terminal sends and an example of an ARP table 12 of an RARP server, respectively;

FIGS. 7A, 7B, and 7C are an example of an application table of a client terminal, an example of a frame containing an RARP request, and an example of a frame containing an RARP response, respectively; and

FIG. 8 is a flow chart showing processes of an AP server, an RARP server, and a client terminal.

### DETAILED DESCRIPTION OF THE PREFERRED EMBODIMENTS

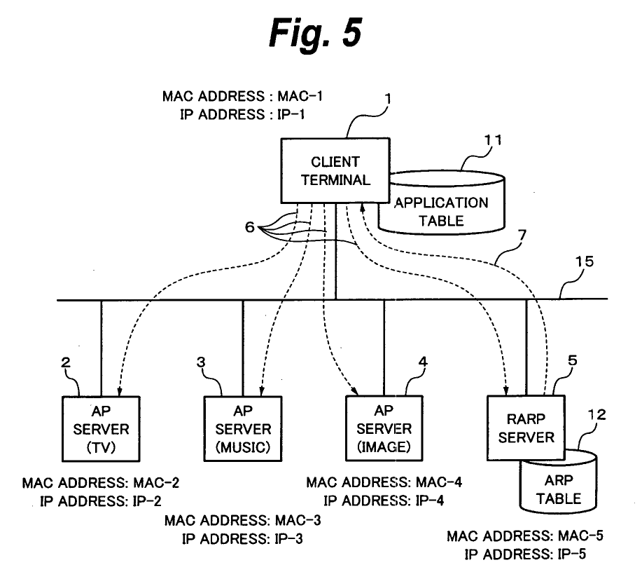

Next, with reference to FIG. 5 to FIG. 8, the network structure and operation of a network system according to the present invention will be described. FIG. 5 is a schematic diagram showing an example of the network structure of the network system according to the present invention. The network system is composed of a network 15, a client terminal 1, an application (AP) server 2, an AP server 3, an AP server 4, and an RARP server 5. In this example, the network 15 is a so-called IP network through which each terminal connected thereto sends and receives data in accordance with IP.

In the network system, the client terminal 1 may be a wireless liquid crystal television and the AP server 2 may be a base station that distributes a television broadcast to the wireless liquid crystal television through a wireless LAN (in according with for example IEEE 802.11b) or that allows the client terminal 1 to be connected to the Internet.

In this example, the RARP server 5 corresponds to an address resolving server. An application table 11 (that will be described later) corresponds to first recording means. An ARP table 12 (that will be described later) corresponds to second recording means.

FIG. 5 also shows MAC addresses and IP addresses of these terminals. For example, the MAC address and IP address of the client 1 are MAC-1 and IP-1, respectively. In the Ethernet system, a real MAC address is binary data of six bytes. An IP address of IPv4 is binary data of four bytes. However, this specification adopts a convenient notation such as MAC-1 and so forth.

It is assumed that each terminal is not a special terminal such as a disc-less workstation, but is pre-assigned an IP address. These terminals broadcast ARP request packets to the network so as to determine whether or not their IP addresses are being used over the network when they get started or at predetermined intervals. ARP request packets broadcast from the client terminal 1 are denoted by arrowed dotted lines 6 shown in FIG. 5.

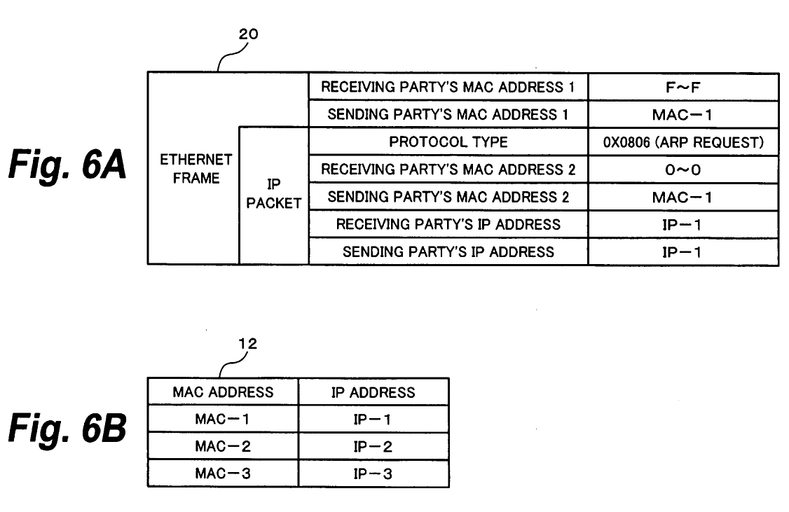

FIG. 6A shows an example of an Ethernet frame 20 that contains an ARP request packet. The Ethernet frame 20 contains a receiving party's MAC address, a sending party's MAC address, and an IP packet. In this example, an IP packet corresponds to an ARP request packet. It should be noted that the items of the Ethernet frame 20 shown in FIG. 6A are only those that are necessary for explanation of the present invention. In other words, the Ethernet frame 20 shown in FIG. 6A does not represent a strict frame layout. The Ethernet frame 20 contains MAC addresses referenced in a network layer (of Open Systems Interconnection (OSI) reference model) and MAC addresses referenced in a lower layer than the network layer. In this example, the former is referred to as MAC addresses 2 (receiving party's MAC address 2 and sending party's MAC address 2), whereas the latter is referred to as MAC addresses 1 (receiving party's MAC address 1 and sending party's MAC address 1).

The receiving party's MAC address 1 of the Ethernet frame 20 describes a value (F-F) of which all bits are 1's so as to broadcast this frame to the network. The sending party's MAC address 1 describes MAC-1 as the MAC address of the client terminal 1. A protocol type of the IP packet describes information that represents an ARP request. In this example, the protocol type is simply denoted. In reality, an ARP request is represented by a protocol bit and an operation bit. Like the sending party's MAC address 1, the sending party's MAC address 2 describes MAC-1 as the MAC address of the client terminal 1. In addition, both a receiving party's IP address and a sending party's IP address of the Ethernet frame 20 describe IP-1 as the IP address of the client terminal 1.

Since the receiving party's IP address describes IP-1, when there is a terminal whose IP address is IP-1 over the network, the terminal sends back an ARP response packet to the client terminal 1. Thus, when any terminal does not respond to the ARP request packet that the client terminal 1 has broadcast, the IP address does not overlap. Consequently, the client terminal 1 can get started with the IP address IP-1.

FIG. 6B shows contents of the ARP table 12 that the RARP server 5 has. As was described in the section of Description of the Related Art, the RARP server 5 has a ARP table that is preset. However, according to the present invention, the RARP server 5 receives the ARP request packets that the terminals broadcast when they get started and so forth. As a result, the RARP server 5 obtains the IP addresses and MAC addresses of the terminals and records the received IP addresses and MAC addresses to the ARP table 12. As is clear from the Ethernet frame 20 shown in FIG. 6A, the sending party's MAC address 1 and the sending party's MAC address 2 describe for example MAC-1 as the MAC address of the sending party. The sending party's IP address describes for example IP-1 as the IP address of the sending party. When the RARP server 5 receives an ARP request, the RARP server 5 adds the MAC address and the IP address as a pair to the ARP table 12.

The ARP table 12 shown in FIG. 6B is generated with the ARP request packets received from the client terminal 1, the AP server 2, and the AP server 3. It is preferred that the entries of the ARP table 12 should be deleted after a predetermined period elapses. This is because IP addresses of terminals may be changed.

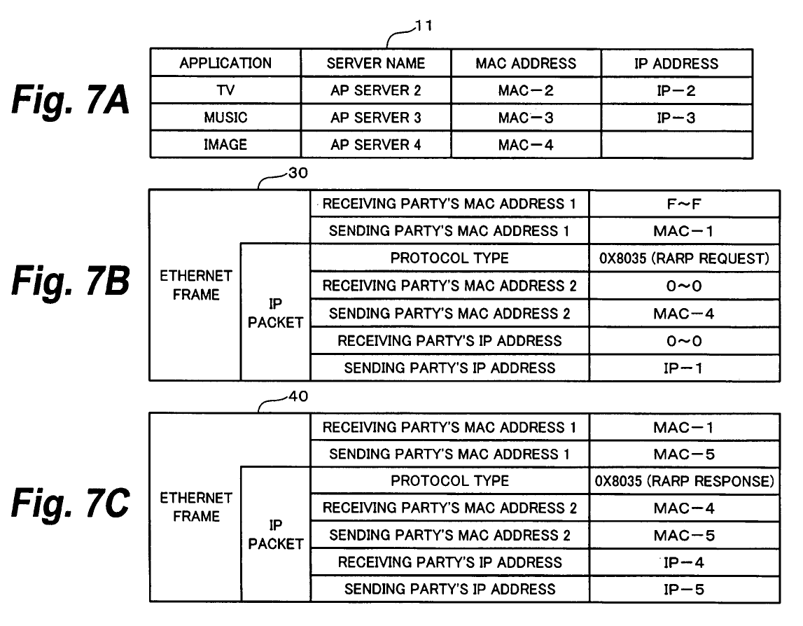

The client terminal 1 shown in FIG. 5 has an application table 11. FIG. 7A shows an example of the application table 11. The application table 11 represent the relation of applications, AP servers, and their MAC addresses. When the user issues a predetermined command that causes the client terminal 1 to reproduce a television broadcast, the client terminal 1 accesses a television application server that reproduces the television broadcast.

In the example, a TV application that distributes a moving picture and sound of a television broadcast is executed by the AP server 2. The MAC address of the AP server 2 is MAC-2. A music application that distributes music provided from a predetermined recording medium is executed by the AP server 3. The MAC address of the AP server 3 is MAC-3. An image application that distributes a moving picture and a still picture provided from a predetermined recording medium is executed by the AP server 4. The MAC address of the AP server 4 is MAC-4. Thus, there is an assumption that the client terminal 1 knows an MAC address of a server that the client terminal 1 uses. When a server is shipped along with the network system, the application table 11 has an MAC address of the server. However, when a server is added after the network system is built, an MAC address of the server should be added to the application table 11. An added MAC address may be supplied with a portable recording medium. Alternatively, a tool that allows the client terminal 1 to input an MAC address may be provided.

In the example shown in FIG. 7A, an IP address obtained in accordance with an AP server's IP address obtaining method (that will be described later) is recorded as it is. In this example, IP-2 as the IP address of the AP server 2 and IP-3 as the IP address of the AP server 3 are pre-obtained and recorded in the application table 11. Thus, when the client terminal 1 accesses the IP addresses of the AP servers, the client terminal 1 does not need to perform the IP address obtaining process. Since the IP addresses of the AP servers may be changed, the IP addresses that have been obtained in accordance with this method may be deleted after a predetermined period elapses.

Next, a process for obtaining an IP address of an AP server that the client terminal 1 accesses will be described. When the application of the client terminal 1 issues an access request to the AP server, the client terminal 1 determines whether or not the IP address of the AP server is pre-registered in the application table 11.

When the IP address is pre-registered in the application table 11, the client terminal 1 accesses the AP server with the IP address. When the IP address is not pre-registered, the client terminal 1 obtains the IP address of the AP server with an RARP request packet. As described above, an RARP request packet is originally used to obtain an IP address of a client terminal. However, according to the present invention, with an RARP request packet, an IP address of another AP server is obtained in accordance with RARP.

The client terminal 1 generates an Ethernet frame 30 that contains an RARP request as shown in FIG. 7B and broadcasts the RARP request to the network. This is because the client terminal 1 does not know the IP address of the RARP server 5.

A receiving party's MAC address 1 of the Ethernet frame 30 describes a value (F-F) of which all bits are 1's so as to broadcast the frame to the network. A sending party's MAC address 1 of the Ethernet frame 30 describes MAC-1 as the MAC address of the client terminal 1. A protocol type of an IP packet of the Ethernet frame 30 describes information that represents an RARP request. Like the foregoing example, the protocol type is simply denoted.

A sending party's MAC address 2 of the Ethernet frame 30 describes an MAC address of an AP server whose IP address the client terminal 1 obtains rather than the MAC address of the client terminal 1. In this example, the sending party's MAC address 2 describes MAC-4 as the MAC address of the AP server 4. The MAC address of the AP server 4 is obtained by referencing the application table 11. A sending party's IP address of the Ethernet frame 30 describes IP-1 as the IP address of the client terminal 1 as the sending party.

When the RARP server 5 receives the RARP request packet, the RARP server 5 generates an Ethernet frame 40 that contains an RARP response packet shown in FIG. 7C and uni-casts the Ethernet frame 40 to the client terminal 1. A receiving party's MAC address 1 of the Ethernet frame 40 describes the sending party's MAC address of the Ethernet frame 30, namely MAC-1 as the MAC address of the client terminal 1. A sending party's MAC address 1 of the Ethernet frame 40 describes MAC-5 as the MAC address of the RARP server 5. A protocol type of an IP packet of the Ethernet frame 40 describes information that represents an RARP response. Like the foregoing, the protocol type is simply denoted.

A receiving party's MAC address 2 of the Ethernet frame 40 normally describes the sending party's MAC address 2 of the Ethernet frame 30, namely MAC-4 as the MAC address of the AP server 4. A sending party's MAC address 2 of the Ethernet frame 40 describes MAC-5 as the MAC address of the RARP server.

With respect to a receiving party's IP address of the Ethernet frame 40, the ARP table 12 shown in FIG. 6B is searched for an IP address corresponding to MAC-4 as the sending party's MAC address 2 of the Ethernet frame 30. As a result, IP-4 is selected and set as the receiving party's IP address. A sending party's IP address of the Ethernet frame 40 describes IP-5 as the IP address of the RARP server 5.

When the client terminal 1 receives the RARP response packet from the RARP server 5, the client terminal 1 knows that the IP address of the AP server 4 is IP-4. Thereafter, the client terminal 1 accesses the AP server 4 with the IP address IP-4. The client terminal 1 newly records IP-4 as an IP address corresponding to MAC-4 to the application table 11.

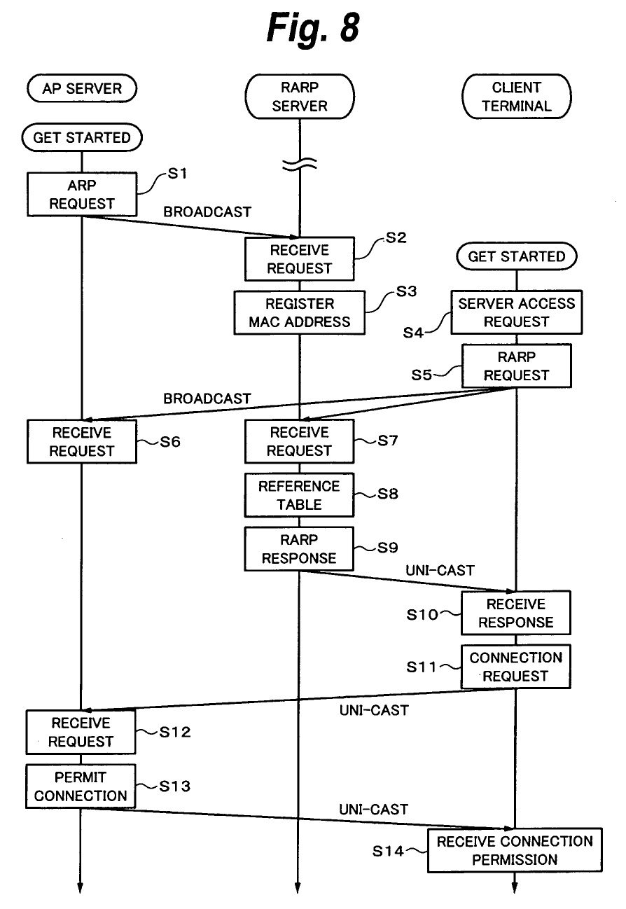

Next, with reference to a flow chart shown in FIG. 8, a process according to the present invention will be described. FIG. 8 shows flows of process parts of an AP server, an RARP server, and a client terminal. In FIG. 8, messages exchanged among the AP server, the RARP server, and the client terminal are denoted by arrow marks. The AP server is for example the AP server 2, the AP server 3, or the AP server 4. First of all, a process part for registering the MAC address of the AP server to the RARP server 5 will be described.

In this example, it is assumed that the RARP server 5 has gotten started. When the AP server gets started, the AP server broadcasts the ARP request to the RARP server 5 at step S1. The RARP server 5 receives the ARP request at step S2. The RARP server 5 registers the MAC address and IP address of the AP server to the ARP table 12 at step S3.

These steps cause the MAC address and IP address of the AP server that has newly gotten started to the ARP table 12 of the RARP server 5. If necessary, when client terminal 1 gets started, the MAC address and IP address of the AP server may be recorded to the ARP table 12. Alternatively, the MAC address and IP address may be recoded to the ARP table 12 at a predetermined time or predetermined intervals.

Next, a process part of the client terminal 1 that obtains the IP address of the AP server and accesses the AP server with the IP address will be described.

After the client terminal 1 gets started and accesses the network system, when the client terminal 1 receives a command from the user, a corresponding application of the client terminal 1 issues an access request to a corresponding AP server at step S4. The client terminal 1 references the application table 11 and obtains an MAC address of an AP server to be accessed (connected). To obtain an IP address of the service application, the client terminal 1 broadcasts a frame that contains an RARP request to the network at step s5. When an IP address of the AP server has been obtained with reference to the application table 11, steps S5 to S10 are omitted. In this case, the client terminal 1 issues a connection request to the AP server at step S11.

When the RARP server 5 receives the RARP request from the client terminal 1 at step S7, the RARP server 5 references the ARP table 12 and obtains an IP address of the AP server that the client terminal 1 tries to access at step S8. When the RARP server 5 has obtained an IP address of he AP server, the RARP server 5 sets the IP address to an IP header and uni-casts an RARP response to the client terminal 1 at step S9.

Since the client terminal 1 broadcasts the RARP request to the network, it is sent to the AP server and so forth. The AP server and so forth receive the RARP request at step S6. However, in this example, since the AP server and so forth are not assigned as RARP servers, they do not perform any process against the RARP request, but discard the received packets.

When the client terminal 1 receives an RARP response from the RARP server 5 at step S10, the client terminal 1 can obtain the IP address of the AP server to which the client terminal 1 tries to access. The client terminal 1 issues a connection request to the AP server with the MAC address and IP address of the AP server and so forth at step S11.

The AP server receives the connection request from the client terminal 1 and checks the contents of the connection request at step S12. When the contents satisfy a predetermined condition, the AP server sends a connection permission response to the client terminal 1 at step S13.

When the client terminal 1 receives the connection permission response from the AP server at step S14, the client terminal 1 accesses the AP server and sends and receives predetermined data to and from the AP server.

In such a manner, the RARP server 5 generates an RARP response packet corresponding to the contents of the ARP table 12 and sends the RARP response packet to the client terminal 1. Since the contents of the ARP table 12 are generated in accordance with an ARP request sent when each terminal gets started, even if the IP address of each terminal is changed, the changed IP address is reflected to the ARP table 12.

On the other hand, the client terminal 1 can obtain an IP address of an AP server that the client terminal 1 tries to access in accordance with the conventional RARP, namely by broadcasting a conventional RARP request to the network, it is not necessary to largely change software of the client terminal 1 and the RARP server 5.

The present invention was described on the basis of IPv4. However, the present invention can be applied to other versions of IP. Moreover, in the foregoing example, a plurality of AP servers are disposed corresponding to applications. Alternatively, one AP server may be disposed for a plurality of applications. In addition, an AP server and an RARP server may be integrated as one server.

Although the present invention has been shown and described with respect to a best mode embodiment thereof, it should be understood by those skilled in the art that the foregoing and various other changes, omissions, and additions in the form and detail thereof may be made therein without departing from the spirit and scope of the present invention.

1. A network system having a client terminal, an application server, and an address network server that are connected to an IP network,
wherein the client terminal has first recording means for recording an MAC address of an application server to which an application of the client terminal is connected, the application providing a predetermined service to the user,
wherein the address resolving server has second recording means for recording an MAC address and an IP address of the application server, and
wherein when the client terminal broadcasts a predetermined request that contains the MAC address of the application server to the network, the address resolving server is configured to receive the predetermined request, obtain the IP address corresponding to the MAC address of the application server from the second recording means, and send back a predetermined response that contains the obtained IP address to the client terminal.

2. The network system as set forth in claim 1,
wherein the predetermined request is an RARP request and the predetermined response is an RARP response.

3. The network system as set forth in claim 2,
wherein the client terminal is configured to designate the MAC address of the application server as a sending party's MAC address of the IP header so as to generate the RARP request.

4. The network system as set forth in claim 2,
wherein the address resolving server is configured to receive an ARP request from the application serve, obtain the MAC address and the IP address of the application server, and record the obtained MAC address and IP address of the application server to the second recording means.

5. The network system as set forth in claim 2,
wherein when the application of the client terminal is connected to the application server and the IP address of the application server to be connected has not been recorded in the first recording means, the client terminal is configured to broadcast the RARP request that contains the MAC address of the application server to the network.

6. The network system as set forth in claim 1,
wherein the network is a wired LAN or a wireless LAN.

7. The network system as set forth in claim 5,
wherein the application server is composed of a plurality of servers each of which has a unique MAC address and an unique IP address, and
wherein the client terminal is configured to select a server to be connected from the servers in accordance with the MAC address of the application with reference to the first recording means.

8. The network system as set forth in claim 2,
wherein the application server and the address resolving server are integrated as one server.

9. A terminal setting method for a network system having a client terminal, an application server, and an address network server that are connected to an IP network, the client having first recording means for recording an MAC address of an application server to which an application of the client terminal is connected, the application providing a predetermined service to the user, the address resolving server having second recording means for recording an MAC address and an IP address of the application server, the terminal setting method comprising the steps of:
causing the client terminal to broadcast a predetermined request that contains the MAC address of the application server to the network;
causing the address resolving server to receive the predetermined request, obtain the IP address corresponding to the MAC address of the application server from the second recording means, and send back a predetermined response that contains the obtained IP address to the client terminal.

10. The terminal setting method as set forth in claim 9,
wherein the predetermined request is an RARP request and the predetermined response is an RARP response.

11. The terminal setting method as set forth in claim 10, further comprising the step of:
causing the client terminal to designate the MAC address of the application server as a sending party's MAC address of the IP header so as to generate the RARP request.

12. The terminal setting method as set forth in claim 10, further comprising the step of:
causing the address resolving server to receive an ARP request from the application serve, obtain the MAC address and the IP address of the application server and record the obtained MAC address and IP address of the application server to the second recording means.

13. The terminal setting method as set forth in claim 10, further comprising the step of:
causing the client terminal to broadcast the RARP request that contains the MAC address of the application server to the network when the application of the client terminal is connected to the application server and the IP address of the application server to be connected has not been recorded in the first recording means.

14. The terminal setting method as set forth in claim 9,
wherein the network is a wired LAN or a wireless LAN.

15. The terminal setting method as set forth in claim 13,
wherein the application server is composed of a plurality of servers each of which has a unique MAC address and an unique IP address, and
wherein the terminal setting method further comprises the step of:
causing the client terminal to select a server to be connected from the servers in accordance with the MAC address of the application with reference to the first recording means.

16. The terminal setting method as set forth in claim 10,
wherein the application server and the address resolving server are integrated as one server.

17. An address resolving server connected to a client terminal and an application server through an IP network, the address resolving server comprising:
second recording means for recording an MAC address and an IP address of the application server,
wherein when the client terminal broadcasts a predetermined request that contains the MAC address of the application server to the network, the address resolving server is configured to receive the predetermined request, obtain the IP address corresponding to the MAC address of the application server from the second recording means, and send back a predetermined response that contains the obtained IP address to the client terminal.

18. The address resolving server as set forth in claim 17,
wherein the predetermined request is an RARP request and the predetermined response is an RARP response.

19. The address resolving server as set forth in claim 18,
wherein the address resolving server is configured to receive an ARP request from the application serve, obtain the MAC address and the IP address of the application server, and record the obtained MAC address and IP address of the application server to the second recording means.

20. The address resolving server as set forth in claim 17,
wherein the network is a wired LAN or a wireless LAN.

21. The address resolving server as set forth in claim 18,
wherein the address resolving server is integrated with the application server.

22. A client terminal, connected to an application server and an address resolving server through an IP network, for executing an application connected to the application server so as to provide a predetermined service to the user, the client terminal comprising:
first recording means for recording an MAC address of the application server,
wherein the client terminal is configured to broadcast a predetermined request that contains the MAC address of the application server to the network so as to obtain an IP address corresponding to the MAC address of the application server to be connected.

23. The client terminal as set forth in claim 22,
wherein the predetermined request is an RARP request and the predetermined response is an RARP response.

24. The client terminal as set forth in claim 23,
wherein the client terminal is configured to designate the MAC address of the application server as a sending party's MAC address of the IP header so as to generate the RARP request.

25. The client terminal as set forth in claim 23,
wherein when the application of the client terminal is connected to the application server and the IP address of the application server to be connected has not been recorded in the first recording means, the client terminal is configured to broadcast the RARP request that contains the MAC address of the application server to the network.

26. The client terminal as set forth in claim 22,
wherein the network is a wired LAN or a wireless LAN.

27. The client terminal as set forth in claim 25,
wherein the application server is composed of a plurality of servers each of which has a unique MAC address and an unique IP address, and
wherein the client terminal is configured to select a server to be connected from the servers in accordance with the MAC address of the application with reference to the first recording means.

28. The client terminal as set forth in claim 23,
wherein the application server and the address resolving server are integrated as one server.
